(19) United States
(12) Patent Application Publication
(10) Pub. No.: US 2026/0032700 A1
(43) Pub. Date: Jan. 29, 2026

(54) TECHNIQUES FOR JOINT COMMUNICATION AND RADAR SIGNALS IN WIRELESS COMMUNICATIONS

(71) Applicant: QUALCOMM Incorporated, San Diego, CA (US)

(72) Inventors: Preeti KUMARI, San Diego, CA (US); Stelios STEFANATOS, San Diego, CA (US); Kapil GULATI, Belle Mead, NJ (US); Junyi LI, Greentown, PA (US); Shuanshuan WU, San Diego, CA (US); Sourjya DUTTA, Jersey City, NJ (US)

(21) Appl. No.: 18/998,459

(22) PCT Filed: Sep. 18, 2023
(86) PCT No.: PCT/US2023/074482

§ 371 Date: Jan. 24, 2025

(30) Foreign Application Priority Data
Sep. 23, 2022 (GR) 20220100783

(51) Int. Cl. H04W 72/25; H04B 7/06; H04L 27/26

(52) U.S. Cl. CPC H04W 72/25; H04B 7/0639; H04L 27/2656

(57) ABSTRACT

Aspects described herein relate to transmitting, by a user equipment (UE) to one or more other UEs, sidelink control information (SCI) over sidelink control channel resources in a pool of resources allocated for sidelink communications, where the SCI indicates one or more parameters related to the comb pattern, and transmitting, using the comb pattern, the radar signal to the one or more other UEs over sidelink shared channel resources. Other aspects relate to receiving the SCI and receiving the radar signal according to the comb pattern.

### CROSS-REFERENCE TO RELATED APPLICATIONS

This application claims the benefit of Greek patent application No. 20220100783, entitled TECHNIQUES FOR JOINT COMMUNICATION AND RADAR SIGNALS IN WIRELESS COMMUNICATIONS, and filed on Sep. 23, 2022, which is expressly incorporated by reference herein in its entirety.

### FIELD OF THE DISCLOSURE

Aspects of the present disclosure relate generally to wireless communication systems, and more particularly, to techniques for communicating joint communication and radar signals.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In 5G NR, for example, devices can transmit radar signals to indicate presence of the device to other nearby devices. In some implementations, the radar signals can be transmitted as, or along with, data signals in a joint communication and radar system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication includes processor, memory coupled with the processor, and instructions stored in the memory. The instructions are operable, when executed by the processor, to cause the apparatus to select a comb pattern for transmitting a radar signal that includes a data channel communication, transmit, to one or more other UEs, sidelink control information (SCI) over sidelink control channel resources in a pool of resources allocated for sidelink communications, wherein the SCI indicates one or more parameters related to the comb pattern, and transmit, using the comb pattern, the radar signal to the one or more other UEs over sidelink shared channel resources.

In another aspect, an apparatus for wireless communication is provided that includes a processor, memory coupled with the processor, and instructions stored in the memory. The instructions are operable, when executed by the processor, to cause the apparatus to receive, from a transmitting UE, SCI over sidelink control channel resources in a pool of resource allocated for sidelink communications, wherein the SCI indicates one or more parameters related to a comb pattern, and receive, using the comb pattern, the radar signal from the transmitting UE over sidelink shared channel resources.

In another aspect, a method for wireless communication at a UE is provided that includes selecting a comb pattern for transmitting a radar signal that includes a data channel communication, transmitting, to one or more other UEs, SCI over sidelink control channel resources in a pool of resources allocated for sidelink communications, wherein the SCI indicates one or more parameters related to the comb pattern, and transmitting, using the comb pattern, the radar signal to the one or more other UEs over sidelink shared channel resources.

In another aspect, a method for wireless communication at a UE is provided that includes receiving, from a transmitting UE, SCI over sidelink control channel resources in a pool of resource allocated for sidelink communications, wherein the SCI indicates one or more parameters related to a comb pattern, and receiving, using the comb pattern, the radar signal from the transmitting UE over sidelink shared channel resources.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 illustrates examples of phase sensing for radar signals, in accordance with aspects described herein;

FIG. 6 is a flow chart illustrating an example of a method for transmitting a joint communication and radar (JCR) signal as a radar signal that include sidelink communications, in accordance with aspects described herein;

FIG. 7 is a flow chart illustrating an example of a method for receiving a JCR signal as a radar signal that include sidelink communications, in accordance with aspects described herein;

FIG. 8 illustrates an example of a resource allocation of contiguous control channel subcarriers for two UEs in a given slot, in accordance with aspects described herein;

FIG. 9 illustrates an example of a resource allocation of non-contiguous control channel subcarriers for at least one UE in a given slot, in accordance with aspects described herein; and

FIG. 10 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to assigning frequency resources in a comb structure for transmitting joint communication and radar (JCR) signals. In some wireless communication technologies, such as fifth generation (5G) new radio (NR), JCR systems can include cooperative JCR systems where some knowledge is shared between the communication and radar systems to improve performance without minimal alteration of the core operation of radar and communication systems, or a co-design of the communication and radar system where a common transmitter or receiver is used for both communication and radar functionalities. Co-designed JCR systems can use a slightly modified waveform generation or receiver processing by the communication and/or radar systems. In an example, at least co-designed JCR systems can allow for spectrum and hardware reuse, which can conserve resource utilization and power consumption at devices communicating the JCR signals.

In one specific example, cyclic prefix (CP)-orthogonal frequency division multiplexing (OFDM) data signals can be used for radar sensing as well. If symbol length is less than radar channel delay spread for radar sensing, a multi-fast Fourier transform (FFT) algorithm can be used for radar detection and estimation. In some examples, multi-FFT per symbol algorithm can meet maximum automotive range requirement of 300 meters in single-target scenario with minimum detectable signal-to-interference-and-noise ratio (SINR) of 15 decibel (dB). One approach to mitigate large symbol energy loss due to long delay spread is to use one-tap frequency domain equalization (FDE) with multi-FFT windows per symbol. For example, for 480 kilohertz (kHz) subcarrier spacing (SCS): First range FFT window for k^{th} symbol can remain the same as the baseline processing (one-tap FDE with single-FFT window per symbol); Second range FFT window for k^{th} symbol can start where the first window corresponding to that symbol ends to fully capture the received k^{th} symbol; Multi-FFT per symbol target detection can be performed based on a first range-Doppler (RD) map estimate, which can have high target SINR for small ranges (with delay bin (d) less than ¼^{th} of FFT size (MFFT), i.e., d<M_{FFT}/4), where RD map estimate can have high target SINR for large ranges (d>3M_{FFT}/4), and RD map obtained by adding both the RD map estimates (leads to noise enhancement) can have high target SINR for medium ranges (M_{FFT}/4<d<3M_{FFT}/4). In general, radar sensing using data part can also enable enhanced JCR performance as compared to time division multiplexing (TDM) approach. In addition, for example, 2-RF performance may be better than 1-RF JCR, where 2-RF performance can be achievable with different waveforms (e.g., with no cross-layer interference).

Using JCR signals, for example, contiguous block of data for simultaneous sensing may lead to large communication overhead due to stringent radar sensing needs, such as wide angular field of view (FoV) with high angular resolution, which may use more beams for scanning mode, high velocity (large coherent processing interval (CPI) and range resolution (large bandwidth), high update rate and high density of radars, etc. In addition, for example, data comb transmission in time-frequency domain may be used to meet radar sensing key performance indicator (KPI) requirements without significant reduction in communication data rate. This may also enable better interference management. Examples described herein relate to different frequency comb designs and signaling for JCR application that can meet radar resolution requirements with less overhead to communication data rate.

Aspects described herein include JCR sidelink resource allocation that may be subchannel based, including different frequency data comb patterns and configurable parameters to reserve resources for simultaneous radar sensing and its associated signaling, sidelink control information (SCI) indication for the chosen data comb pattern and configurable parameters in the frequency domain, and search space for physical sidelink control channel (PSCCH), where receiving UE can find SCI. Using the data comb patterns can allow for high density of radar signals to improve radar operations, and can enable the radar sensing with low data rate overhead, which can improve resource utilization, and thus communication efficiency and quality at the UE.

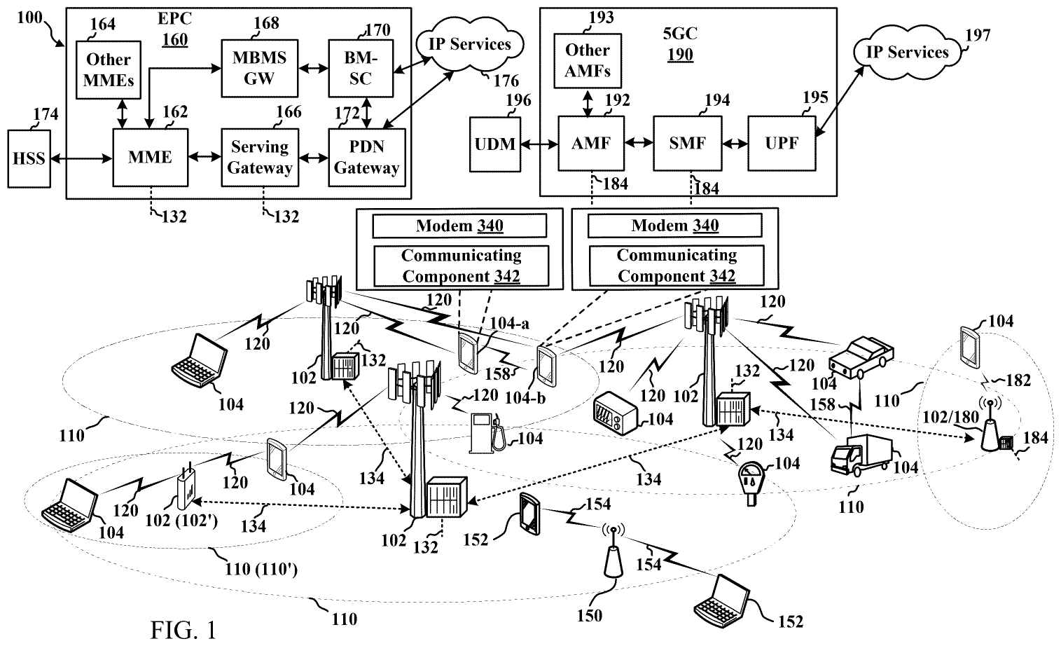

The described features will be presented in more detail below with reference to FIGS. 1-10.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for configuring a comb pattern for JCR signals in sidelink communications, in accordance with aspects described herein. In addition, some nodes may have a modem 440 and BS communicating component 442 for configuring UEs for communicating using sidelink resources, in accordance with aspects described herein. Though UE 104-a and 104-b are shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 (e.g., UEs 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE 104-a can be a SL transmitting UE that can transmit SL communications to multiple SL receiving UEs 104-b. In this example, the SL transmitting UE 104-a can transmit, to the SL receiving UEs 104-b, SCI to schedule resources over which the SL transmitting UE 104-a transmits SL communications to the SL receiving UEs 104-b (e.g., PSSCH communications). According to aspects described herein, the SL transmitting UE 104-a can transmit SCI that schedules radar communications (e.g., JCR signals) for one or more SL receiving UEs 104-b. For example, UE communicating component 342 of a SL transmitting UE 104-a can transmit SCI that schedules JCR signals in a comb pattern in frequency. In this example, UE communicating component 342 of a SL receiving UE 104-b can receive the SCI that schedules JCR signals in the comb pattern in frequency. The SL transmitting UE 104-a and/or SL receiving UE 104-b can accordingly communicate JCR signals based on the comb pattern.

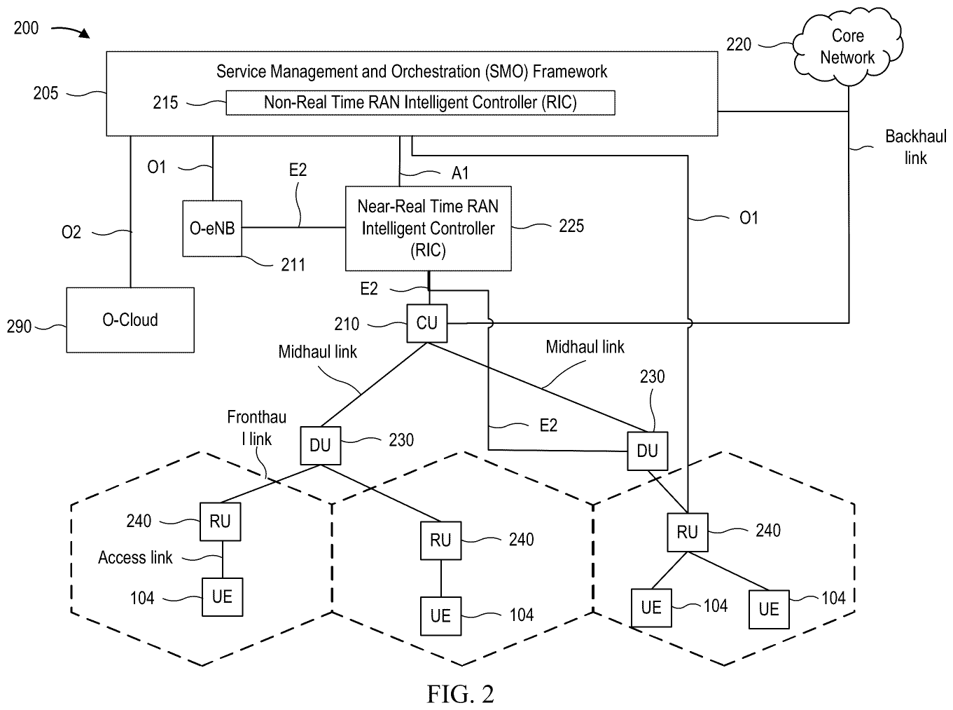

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

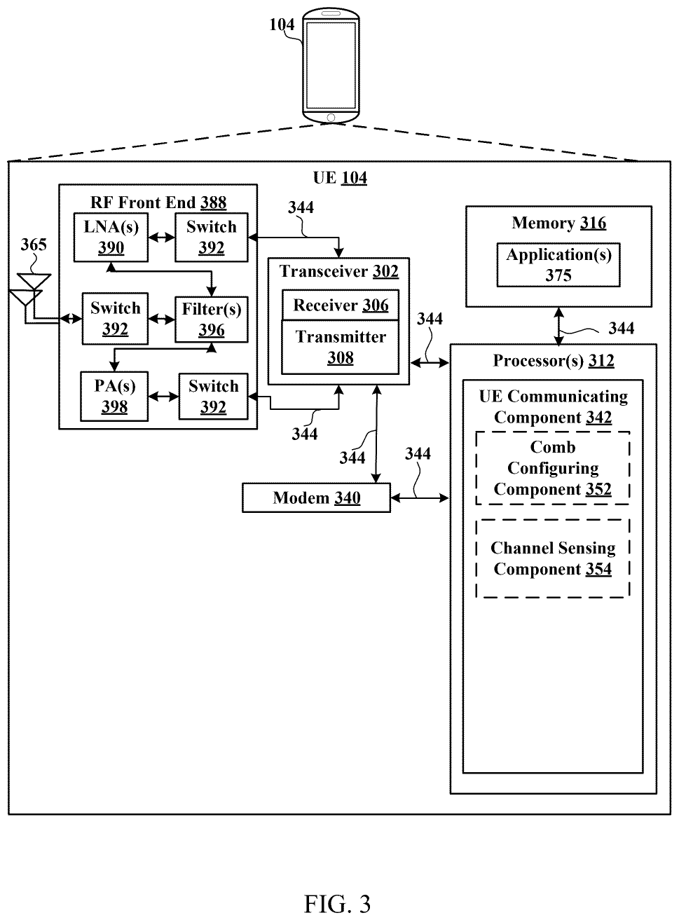

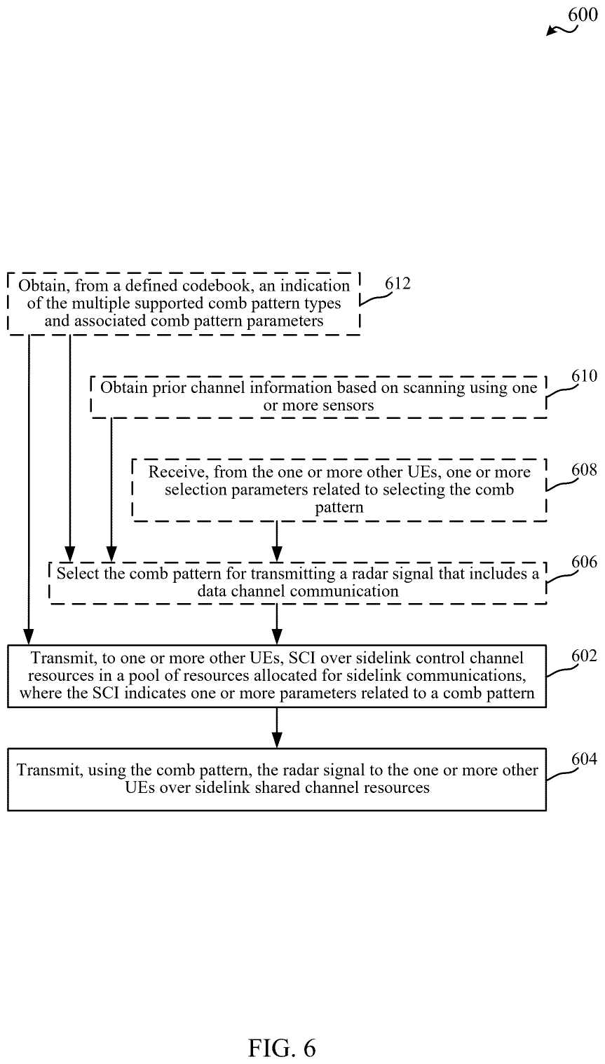

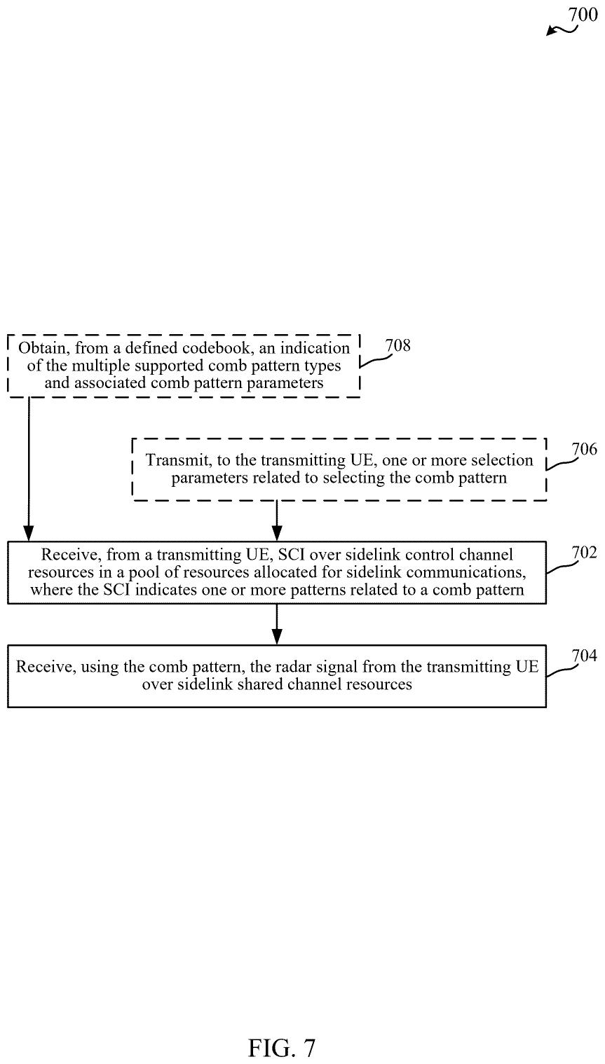

Turning now to FIGS. 3-8, aspects are depicted with reference to one or more components and one or more methods that may perform the actions or operations described herein, where aspects in dashed line may be optional. Although the operations described below in FIGS. 6 and 7 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for configuring a comb pattern for JCR signals in sidelink communications, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof.

In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a comb configuring component 352 for generating or processing a configuration indicating a comb pattern for communicating radar signals (e.g., JCR signals) in sidelink communications, and/or a channel sensing component 354 for sensing channel conditions of a sidelink channel, in accordance with aspects described herein. For example, where the UE 104 is a SL transmitting UE, comb configuring component 352 can generate and/or transmit the configuration that indicates the comb pattern of frequency resources for a SL receiving UE to use in communicating JCR signals. For example, where the UE 104 is a SL receiving UE, comb configuring component 352 can receive and/or process the configuration that indicates the comb pattern of frequency resources.

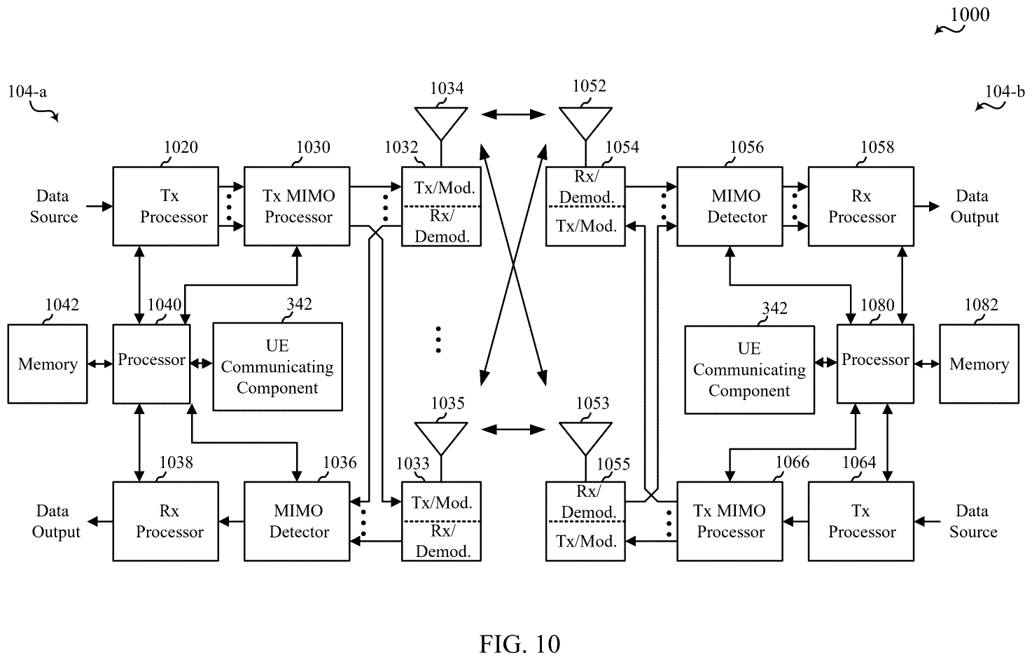

In an aspect, the processor(s) 312 may correspond to one or more of the processors described in connection with the UE in FIG. 10. Similarly, the memory 316 may correspond to the memory described in connection with the UE in FIG. 10.

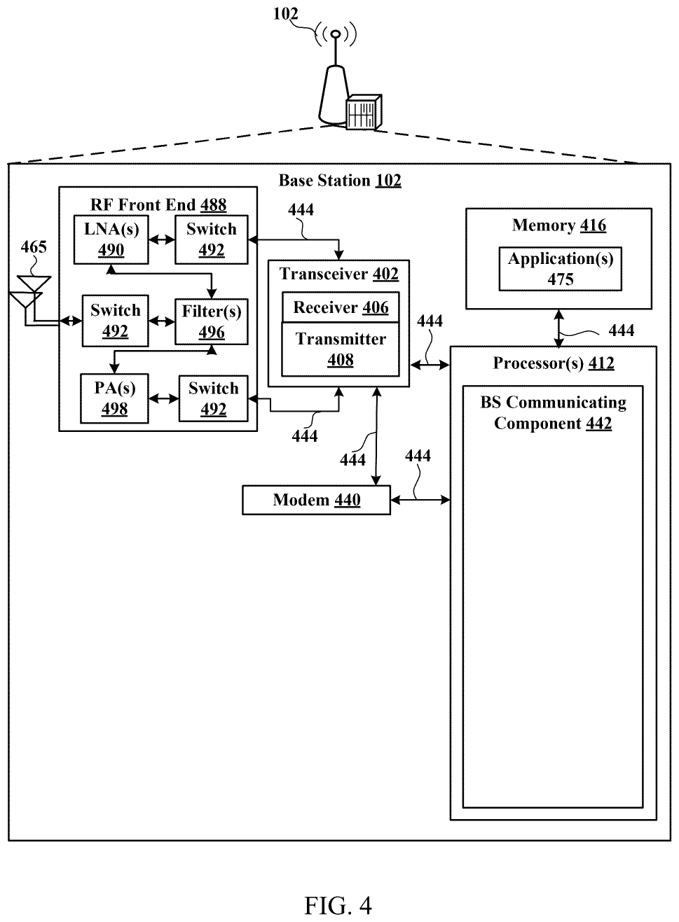

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for configuring UEs for communicating using sidelink resources, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, the processor(s) 412 may correspond to one or more of the processors described in connection with the base station in FIG. 10. Similarly, the memory 416 may correspond to the memory described in connection with the base station in FIG. 10.

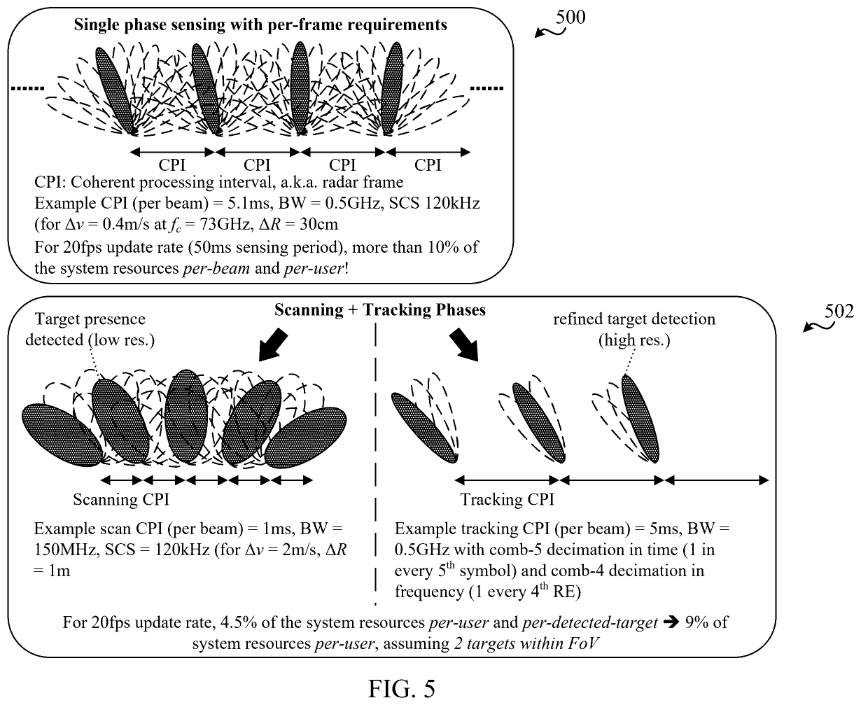

FIG. 5 illustrates examples of phase sensing for radar signals. Communications between devices in automobiles can benefit from high density of radars with high-resolution and high-update rate. Phase sensing can include single phase sensing, as shown at 500, which may lead to large communication overhead with back-to-back comb transmission. In single phase sensing, a UE can be configured with a coherent processing interval (CPI, also referred to as a radar frame) during which the UE can sense a radar signal. In this example, with a 20 frame per second update rate (50 millisecond sensing period), more than 10% of the system resources can be used per beam and per UE.

Phase sensing can include multi-phase sensing, as shown at 502, which may enable radar sensing with low data rate overhead with sparse comb pattern. For example, in a first (scanning) phase, target presence can be detected with low resolution, and in a second (tracking) phase, target direction for detected targets can be refined with high resolution. The CPI for the scanning phase can be smaller than that used in single phase sensing, and the overhead can still be smaller than single phase scanning-e.g., with a 20 frame per second update rate, than 4.5% of the system resources can be used per beam and per UE, and 9% of system resources per user can be used assuming two targets within field of view (FoV).

In 5G NR, interlaced channel structure can be used for sidelink communications in unlicensed band, which can allow for achieving occupied channel bandwidth (OCB) requirements. A transmission from a SL UE can occupy one or multiple interlaced resource RB groups, where one interlaced RB group includes RBs that are evenly spaced in frequency within the available channel bandwidth. In 5G NR, the interlaced pattern is adopted with uniform spacing for entire channel bandwidth, and this structure may not be sufficient and flexible enough to reduce communication data rate for radar sensing with desired requirements. Accordingly, aspects described herein relate to a frequency comb pattern for a UE, which can be selected by the UE. The frequency comb pattern can include enhanced uniform and/or non-uniform comb patterns within a configurable transmission bandwidth of the UE. In addition, a SL transmitting UE can transmit an SCI indication of the frequency comb pattern for JCR signals, where the JCR signals can include a sidelink communications signal that is also used for radar sensing.

FIG. 6 illustrates a flow chart of an example of a method 600 for transmitting a JCR signal as a radar signal that include sidelink communications, in accordance with aspects described herein. FIG. 7 illustrates a flow chart of an example of a method 700 for receiving a JCR signal as a radar signal that include sidelink communications, in accordance with aspects described herein. In an example, a UE functioning as a SL transmitting UE 104-a in sidelink communications can perform the functions described in method 600 using one or more of the components described in FIGS. 1 and 3. In an example, a UE functioning as a SL receiving UE 104-b in sidelink communications can perform the functions described in method 700 using one or more of the components described in FIGS. 1 and 3. Methods 600 and 700 are described in conjunction with one another for ease of explanation; however, the methods 600 and 700 are not required to be performed together and indeed can be performed independently using separate devices.

In method 600, at Block 602, SCI can be transmitted, to one or more other UEs, over sidelink control channel resources in a pool of resources allocated for sidelink communications, where the SCI indicates one or more parameters related to a comb pattern. In an aspect, comb configuring component 352, e.g., in conjunction with processor(s) 312, memory 316, transceiver 302, UE communicating component 342, etc., of a SL transmitting UE 104-a, can transmit, to the one or more other UEs (e.g., one or more SL receiving UEs 104-b), the SCI over sidelink control channel resources in a pool of resources allocated for sidelink communications, where the SCI indicates one or more parameters related to the comb pattern. For example, the SL transmitting UE 104-a can be allocated with the pool of resources for sidelink communications in a Type 2 SL resource allocation, which may include a base station 102 specifying the pool of resources from which SL UEs can select resources for transmitting SL communications. In examples described herein, comb configuring component 352 can accordingly autonomously select resources from the pool of resources for transmitting sidelink communications in JCR signals, and can generate SCI to indicate the selected resources to other SL receiving UEs, where the resources can be based on (and can be indicated as) a frequency comb pattern. Comb configuring component 352 can transmit the SCI over sidelink control channel resources, such as PSCCH, which can be selected from the pool of resources and/or can be selected as resources configured for a search space for PSCCH, as described further herein.

In method 700, at Block 702, SCI can be received, from a transmitting UE, over sidelink control channel resources in a pool of resources allocated for sidelink communications, where the SCI indicates one or more parameters related to a comb pattern. In an aspect, comb configuring component 352, e.g., in conjunction with processor(s) 312, memory 316, transceiver 302, UE communicating component 342, etc., of a SL receiving UE 104-b, can receive, from the transmitting UE (e.g., a SL transmitting UEs 104-a), the SCI over sidelink control channel resources in a pool of resources allocated for sidelink communications, where the SCI indicates one or more parameters related to the comb pattern. For example, comb configuring component 352 can receive the SCI in a PSCCH, which can include detecting the PSCCH in resources configured as a PSCCH search space, as described further herein. Comb configuring component 352 can identify the comb pattern and/or the resources that are defined in the comb pattern based on the SCI for receiving JCR signals from the SL transmitting UE, which can include sidelink communications and can be used for radar sensing.

In method 600, at Block 604, the radar signal can be transmitted, using the comb pattern, to the one or more other UEs over sidelink shared channel resources. In an aspect, UE communicating component 342, e.g., in conjunction with processor(s) 312, memory 316, transceiver 302, etc., of a SL transmitting UE 104-a, can transmit, using the comb pattern (e.g., over frequency resources indicated by the comb pattern), the radar signal to the one or more other UEs over the sidelink shared channel resources (e.g., over PSSCH).

In method 700, at Block 704, the radar signal can be received, using the comb pattern, from the transmitting UE over sidelink shared channel resources. In an aspect, UE communicating component 342, e.g., in conjunction with processor(s) 312, memory 316, transceiver 302, etc., of a SL receiving UE 104-b, can receive, using the comb pattern (e.g., over frequency resources indicated by the comb pattern), the radar signal from the transmitting UE (e.g., SL transmitting UE 104-a) over the sidelink shared channel resources (e.g., over PSSCH). In this example, the SL receiving UE 104-b can process the sidelink communications from the radar signal (the JCR signal) and/or can perform radar operations for the SL transmitting UE 104-a based on sensing the radar signal.

In method 600, optionally at Block 606, the comb pattern can be selected for transmitting the radar signal that includes a data channel communication. In an aspect, comb configuring component 352, e.g., in conjunction with processor(s) 312, memory 316, transceiver 302, UE communicating component 342, etc., of a SL transmitting UE 104-a, can select the comb pattern for transmitting the radar signal that includes the data channel communication (e.g., a PSSCH communication). In one example, comb configuring component 352 can select the comb pattern based on comb pattern types supported by the SL transmitting UE 104-a, comb pattern parameters, comb pattern capabilities of the SL transmitting UE 104-a, etc.

In one example, comb configuring component 352 can select the comb pattern based on signaling exchanges between UEs. For example, in method 600, optionally at Block 608, one or more selection parameters related to selecting the comb pattern can be received from the one or more other UEs. In an aspect, comb configuring component 352, e.g., in conjunction with processor(s) 312, memory 316, transceiver 302, UE communicating component 342, etc., of a SL transmitting UE 104-a, can receive, from the one or more other UEs, one or more selection parameters related to selecting the comb pattern. For example, in method 700, optionally at Block 706, one or more selection parameters related to selecting the comb pattern can be transmitted to the transmitting UE. In an aspect, comb configuring component 352, e.g., in conjunction with processor(s) 312, memory 316, transceiver 302, UE communicating component 342, etc., of a SL receiving UE 104-b, can transmit, to the transmitting UE, one or more selection parameters related to selecting the comb pattern. For example, the one or more selection parameters can include an indication of comb patterns selected by the one or more other UEs (e.g., based on an indication in SCI from the one or more other UEs, the one or more other UEs using the frequency resources in a comb pattern, etc.). Signaling exchange can be used between UEs (for bi-static or multi-static sensing) to select the comb pattern and/or to determine its allocation strategy accordingly from the available resource pool.

In an example, comb configuring component 352 of a SL receiving UE 104-b can transmit, to the SL transmitting UE 104-a, the JCR KPI requirements (or similar resource requirements, such as bandwidth needed for sensing). In this example, comb configuring component 352 of a SL transmitting UE 104-a can receive the JCR KPI requirements of one or more receiving UEs, and can select the comb pattern to have enough frequency resources to achieve the requirements. For example, JCR KPI requirements, which can be specified by the SL receiving UE, can include maximum range/Doppler/angular FoV, resolution in range-Doppler-angular domain, update rate, maximum number of targets, target radar cross section (RCS), minimum communication data rate, etc. Comb configuring component 352 of a SL transmitting UE 104-a can receive the JCR KPI requirements or related parameters from one or more receiving UEs and can select a comb pattern that includes enough frequency resources to achieve the JCR KPI requirements. This may be based on a configured mapping that correlates values for the parameters with an amount of frequency resources needed to achieve the values.

In another example, comb configuring component 352 can select the comb pattern based on prior JCR channel information. For example, in method 600, optionally at Block 610, prior JCR channel information can be obtained based on scanning using one or more sensors. In an aspect, comb configuring component 352, e.g., in conjunction with processor(s) 312, memory 316, transceiver 302, UE communicating component 342, etc., of a SL transmitting UE 104-a, can obtain prior channel information based on scanning using one or more sensors. For example, comb configuring component 352 of a SL transmitting UE 104-a can obtain prior JCR channel information through scanning phase or other sensors, such as coarse range-Doppler-angular estimate, number of targets to be tracked, target RCS, time and frequency selectivity of communication channel, pathloss estimate of communication channel, etc. Comb configuring component 352 of a SL transmitting UE 104-a can select the comb pattern to account for the prior JCR channel information, assuming the current JCR channel has similar properties.

Where the UEs exchange signaling regarding the SL receiving UE's sensing requirements, for example, the SL transmitting UE 104-a can accordingly determine its allocation strategy (e.g., whether comb-based allocation is needed, how wide its comb should span, etc.), and generate the SCI to indicate the comb pattern or related parameters. Sidelink resource allocation may be subchannel based, where subchannel can be defined as a set of M subcarriers (either contiguous or non-contiguous).

In another example, comb configuring component 352 can select the comb pattern from a pre-defined codebook. For example, in method 600, optionally at Block 612, an indication of multiple supported comb pattern types and associated comb pattern parameters can be obtained from a defined codebook. In an aspect, comb configuring component 352, e.g., in conjunction with processor(s) 312, memory 316, transceiver 302, UE communicating component 342, etc., of a SL transmitting UE 104-a, can obtain, from a defined codebook, the indication of the multiple supported comb pattern types and associated comb parameters. For example, comb configuring component 352 can obtain the defined codebook from memory 316 (e.g., as stored in accordance with a wireless communication technology, such as 5G NR), in a configuration from a base station 102, etc. For example, as described further herein, the defined codebook may include one or more uniform comb patterns or associated parameters (e.g., subcarrier spacing between frequency resources defining the comb pattern), one or more non-uniform comb patterns or associated parameters (e.g., starting subcarrier index, subcarrier index of each frequency resource in the comb pattern, etc.), and/or the like.

In another example, comb configuring component 352 can select the comb pattern based on device capability information of the SL transmitting UE 104-a, such as supported bandwidth, bands of operation, maximum duty cycle, maximum transmit power, antenna gain and directivity. For example, comb configuring component 352 can select the comb pattern to include a number of frequency resources and/or a span of frequency resources that comply with the device capability information. In yet another example, comb configuring component 352 can flexibly select the comb pattern parameters to occupy any time symbol and frequency subcarrier from the available resource pool with some constraints, as described further herein.

In an example, comb configuring component 352 of the SL transmitting UE 104-a can communicate its selected comb pattern type and/or comb pattern parameters with the SL receiving UE 104-b. For example, comb configuring component 352 of the SL transmitting UE 104-a can transmit the SCI (e.g., at Block 602) including SCI indication for the chosen comb pattern and configurable pattern parameters. In one example, the SCI indication can include codebook based parameters, such as starting resource element (RE) of the comb pattern, comb pattern type index, configurable parameter of the chosen comb pattern type, net transmission bandwidth, total duration, etc. In another example, the SCI indication can include flexible configured comb pattern types and comb pattern parameters (e.g., when not selected from a pre-defined codebook), such as each RE indexes to be used, net transmission bandwidth, total duration, etc.

In one example, comb configuring component 352 of the SL transmitting UE 104-a can select a uniform comb pattern, such that the frequency resources of the comb pattern can be uniformly spaced in frequency across a channel bandwidth. In this example, comb configuring component 352 can indicate whether the chosen pattern is a uniform pattern and/or may indicate a configurable parameter M denoting the spacing between different subcarriers along with total transmission bandwidth, a duration for the comb pattern over time (e.g., a number of symbols or slots), etc. In one example, the uniform pattern may also include a configurable parameter N denoting a number of consecutive subcarriers in a given tooth of the comb pattern.

In another example, comb configuring component 352 of the SL transmitting UE 104-a can select a non-uniform comb pattern, which may include a defined pattern and/or configurable set of parameters for a given defined pattern. This can enable enhanced radar performance without reducing communication, as compared to uniform pattern. In one example, comb configuring component 352 can define the non-uniform comb pattern as a nested pattern that is obtained by nesting two uniform patterns with different inter-subcarrier spacing. For example, the inter-subcarrier spacing in the two-level nested pattern can be given by {1^{(M)}, (M+1)^{(N)}}, where M is the number of subcarriers in the first uniform pattern and N is the number of subcarriers in the second uniform pattern, where a^{(b)} represents b repetitions of a. In a specific example, comb configuring component 352 can specify a nested pattern and M=3, N=3, such that the subcarrier indices for the comb pattern can be {start RE, start RE+1, start RE+2, start RE+3, start RE+8, start RE+12}. In this example, comb configuring component 352 can generate the SCI to indicate whether the chosen pattern is a nested pattern (or some other defined pattern that follows an equation) with configurable parameter values for M and N along with total transmission bandwidth (optional as this can also be calculated from M and N values), duration, etc.

In another example, comb configuring component 352 of the SL transmitting UE 104-a can select a non-uniform comb pattern as a configurable pattern and some constraints. For example, this can be used for a sparse frequency comb pattern with only a few allocated REs to enable enhanced radar performance without reducing communication, as compared to other two patterns. Some constraints may apply while using this configurable non-codebook mode, such as maximum bandwidth or CPI, or maximum REs that can be allocated, etc. In this example, comb configuring component 352 can generate the SCI to indicate set of RE locations along with total transmission bandwidth (optional as it can be calculated from locations of start RE and end RE), duration, etc.

In any of the above examples, comb configuring component 352 of a SL receiving UE 104-b can receive the SCI (e.g., in Block 702) and accordingly determine the comb pattern, based on the parameters, to use to receive the JCR signals from the SL transmitting UE 104-a. In one example, in method 700, optionally at Block 708, an indication of multiple supported comb pattern types and associated comb pattern parameters can be obtained from a defined codebook. In an aspect, comb configuring component 352, e.g., in conjunction with processor(s) 312, memory 316, transceiver 302, UE communicating component 342, etc., of a SL receiving UE 104-b, can obtain, from a defined codebook, the indication of the multiple supported comb pattern types and associated comb pattern parameters. In this example, comb configuring component 352 of the SL transmitting UE 104-a can transmit, in the SCI, an identifier of the codebook, and comb configuring component 352 of the SL receiving UE 104-b can match the codebook identifier to an associated comb pattern or parameters for determining the code pattern, which UE communicating component 342 of the SL receiving UE 104-b can use for determining the frequency comb pattern resources over which to receive the data communication and/or radar signal, as described.

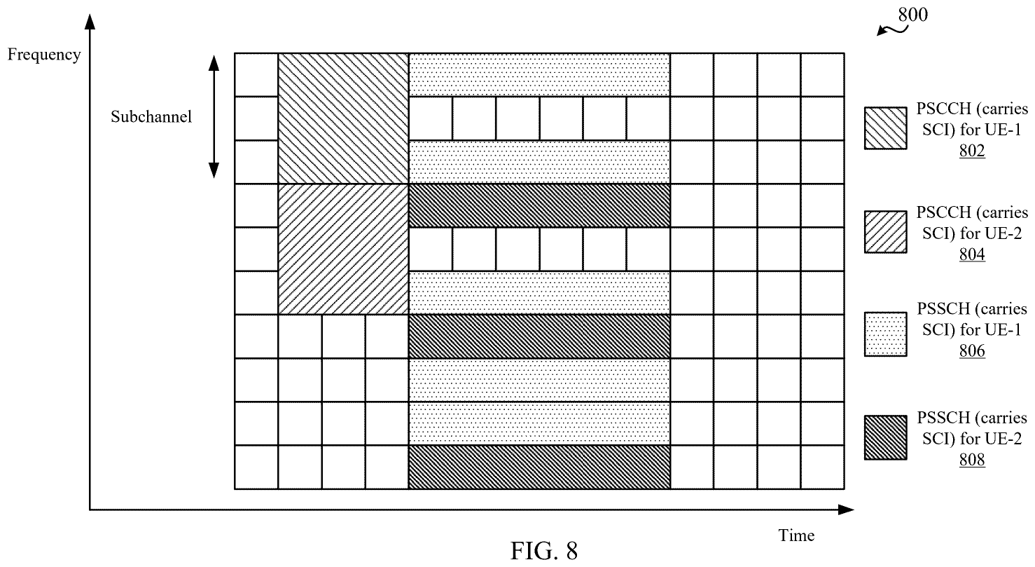

In transmitting the SCI (e.g., at Block 602), the comb configuring component 352 of the SL transmitting UE 104-a can transmit the SCI in time/frequency resources defined for a PSCCH search space, and the comb configuring component 352 of the SL receiving UE 104-b can locate the SCI in resources defined for the PSCCH search space. For example, the comb configuring component 352 of the SL transmitting UE 104-a can select resources for the associated PSCCH to be at the start of the transmission in the second, third, and/or fourth symbols of a slot, and contiguously in the kth subchannel (contiguous set of M subcarriers) for the kth user. The comb configuring component 352 of the SL receiving UE 104-b The RX UE can find the SCI in the expected conventional search space, and the SCI can inform of parameters related to the comb parameters to be used (for PSSCH), as described in the various examples above. An example is shown in FIG. 8.

FIG. 8 illustrates an example of a resource allocation 800 of contiguous control channel subcarriers for two UEs in a given slot. For example, resource allocation 800 can include a PSCCH allocation for UE-1 802 in the second, third, and fourth symbols of the slot in a first subchannel, and a PSCCH allocation for UE-2 804 in the second, third, and fourth symbols of the slot in a second subchannel. The SCI in the PSCCH allocation for UE-1 802 can define a comb pattern for the PSSCH of UE-1 806 as a non-uniform comb pattern in the depicted frequency resources for a duration of 6 symbols. The SCI in the PSCCH allocation for UE-2 804 can define a comb pattern for the PSSCH of UE-2 808 as a uniform comb pattern in the depicted frequency resources for a duration of 6 symbols.

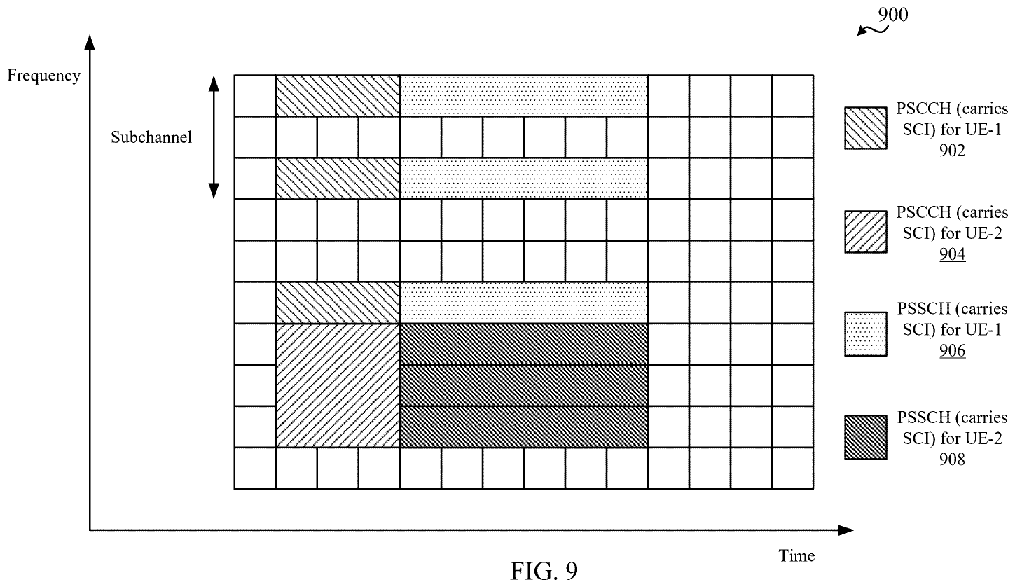

In another example, the comb configuring component 352 of the SL transmitting UE 104-a can select resources for the associated PSCCH to be at the start of the transmission in the second, third, and/or fourth symbols of a slot, in non-contiguously placed subcarriers. The comb configuring component 352 of the SL receiving UE 104-b The RX UE can find the SCI in the non-contiguous subcarriers, as configured, and the SCI can inform of parameters related to the comb parameters to be used (for PSSCH), as described in the various examples above. An example is shown in FIG. 9.

FIG. 9 illustrates an example of a resource allocation 900 non-contiguous control channel subcarriers for at least one UE in a given slot. For example, resource allocation 900 can include a PSCCH allocation for UE-1 902 in the second, third, and fourth symbols of the slot in non-contiguous subcarriers, and a PSCCH allocation for UE-2 904 in the second, third, and fourth symbols of the slot in a subchannel of contiguous subcarriers. In this example, the PSCCH can be placed in one or multiple interspersed subchannels (where, an interspersed subchannel can be defined as M number of non-contiguous subcarriers). Similarly, the sidelink resource allocation for the data part of PSSCH can also be interspersed subchannel based, as shown in the PSSCH for UE-1 906. Additionally, sidelink resource allocation for UE-2, PSSCH for UE-2 908, can be in the subchannel with contiguous subcarriers. SCI indication in multiple interspersed subchannels may enable more robust control information transfer to the SL receiving UE 104-b. For the interspersed subchannel allocation for PSCCH, for example, SCI indication in each subcarrier can also include the RE index for the next subcarrier with SCI bits for a given comb transmission or an indication of the end of SCI information bits for a given UE. In this example, comb configuring component 352 of the SL transmitting UE 104-a can generate the SCI to indicate SCI resource locations of the SCI pattern in the search space, and can transmit the SCI in the SCI resource locations. Comb configuring component 352 of the SL receiving UE 104-b can find the SCI in each subcarrier in the search space, which can include finding an initial subcarrier based on a kth subchannel or based on another indication related to the SL receiving UE 104-b, by blind decoding, and/or the like. Comb configuring component 352 of the SL receiving UE 104-b can determine the other resource locations from the SCI decoded in the first resource location. As described, the SCI can also include parameters related to the comb pattern to be used (e.g., for PSSCH), which comb configuring component 352 can obtain from the SCI to receive the PSSCH according to the comb pattern.

In another example, the comb configuring component 352 of the SL transmitting UE 104-a can generate the SCI to include SCI indication for both current and future transmissions. For future transmissions, for example, the SCI indication can include at least a portion of comb pattern parameters, as described above, along with start RE along with an indication of future transmissions to which the parameters apply. In this example, comb configuring component 352 of the SL receiving UE 104-b can receive the SCI and can apply the parameters for receiving the future transmissions according to the comb pattern as well. For example, the indication of future transmissions can include a number of future transmissions, a timer expiration for which to apply the parameter to the future transmissions, etc. In another example, comb configuring component 352 of the SL transmitting UE 104-a can subsequently send a SCI that disables or modifies the comb pattern, and comb configuring component 352 of the SL receiving UE 104-b can apply the comb pattern for receiving the JCR signals from the SL transmitting UE 104-a until the SCI that disables or modifies the comb pattern is received. The SCI can also be generated to indicate if the future transmission is a retransmission or a continuation of the sensing transmission, in one example. This can allow for providing more robust SCI information transfer to the SL receiving UE 104-b. In one example, using the SCI to indicate comb pattern for future transmissions can also be used with the other examples above, such that after the future transmissions are completed, the search space can for additional transmission can be in the contiguous or non-contiguous subcarriers, as described above.

FIG. 10 is a block diagram of a MIMO communication system 1000 including UEs 104-a, 104-b. The MIMO communication system 1000 may illustrate aspects of the wireless communication access network 100 described with reference to FIG. 1. The UE 104-a may be an example of aspects of the UE 104 described with reference to FIGS. 1 and 3. The UE 104-a may be equipped with antennas 1034 and 1035, and the UE 104-b may be equipped with antennas 1052 and 1053. In the MIMO communication system 1000, the UEs 104-a, 104-b may be able to send data over multiple communication links at the same time. Each communication link may be called a “layer” and the “rank” of the communication link may indicate the number of layers used for communication. For example, in a 2×2 MIMO communication system where UE 104-a transmits two “layers,” the rank of the communication link between the UE 104-a and the UE 104-b is two.

At the UE 104-a, a transmit (Tx) processor 1020 may receive data from a data source. The transmit processor 1020 may process the data. The transmit processor 1020 may also generate control symbols or reference symbols. A transmit MIMO processor 1030 may perform spatial processing (e.g., precoding) on data symbols, control symbols, or reference symbols, if applicable, and may provide output symbol streams to the transmit modulator/demodulators 1032 and 1033. Each modulator/demodulator 1032 through 1033 may process a respective output symbol stream (e.g., for OFDM, etc.) to obtain an output sample stream. Each modulator/demodulator 1032 through 1033 may further process (e.g., convert to analog, amplify, filter, and upconvert) the output sample stream to obtain a DL signal. In one example, DL signals from modulator/demodulators 1032 and 1033 may be transmitted via the antennas 1034 and 1035, respectively.

The UE 104-b may be an example of aspects of the UEs 104 described with reference to FIGS. 1 and 3. At the UE 104-b, the UE antennas 1052 and 1053 may receive the signals from the UE 104-a (e.g., over a sidelink) and may provide the received signals to the modulator/demodulators Each 1054 and 1055, respectively. Each modulator/demodulator 1054 through 1055 may condition (e.g., filter, amplify, downconvert, and digitize) a respective received signal to obtain input samples. Each modulator/demodulator 1054 through 1055 may further process the input samples (e.g., for OFDM, etc.) to obtain received symbols. A MIMO detector 1056 may obtain received symbols from the modulator/demodulators 1054 and 1055, perform MIMO detection on the received symbols, if applicable, and provide detected symbols. A receive (Rx) processor 1058 may process (e.g., demodulate, deinterleave, and decode) the detected symbols, providing decoded data for the UE 104-b to a data output, and provide decoded control information to a processor 1080, or memory 1082.

At the UE 104-b, a transmit processor 1064 may receive and process data from a data source. The transmit processor 1064 may also generate reference symbols for a reference signal. The symbols from the transmit processor 1064 may be precoded by a transmit MIMO processor 1066 if applicable, further processed by the modulator/demodulators 1054 and 1055 (e.g., for SC-FDMA, etc.), and be transmitted to the UE 104-a in accordance with the communication parameters received from the UE 104-a. At the UE 104-a, the signals from the UE 104-b may be received by the antennas 1034 and 1035, processed by the modulator/demodulators 1032 and 1033, detected by a MIMO detector 1036 if applicable, and further processed by a receive processor 1038. The receive processor 1038 may provide decoded data to a data output and to the processor 1040 or memory 1042.

The processor 1040 and/or 1080 may in some cases execute stored instructions to instantiate a UE communicating component 342 (see e.g., FIGS. 1 and 3).

The components of the UEs 104-a, 104-b may, individually or collectively, be implemented with one or more ASICs adapted to perform some or all of the applicable functions in hardware. Each of the noted modules may be a means for performing one or more functions related to operation of the MIMO communication system 1000. Similarly, the components of the UE 104-a may, individually or collectively, be implemented with one or more ASICs adapted to perform some or all of the applicable functions in hardware. Each of the noted components may be a means for performing one or more functions related to operation of the MIMO communication system 1000.

The following aspects are illustrative only and aspects thereof may be combined with aspects of other embodiments or teaching described herein, without limitation.

Aspect 1 is a method for wireless communication at a UE including selecting a comb pattern for transmitting a radar signal that includes a data channel communication, transmitting, to one or more other UEs, SCI over sidelink control channel resources in a pool of resources allocated for sidelink communications, where the SCI indicates one or more parameters related to the comb pattern, and transmitting, using the comb pattern, the radar signal to the one or more other UEs over sidelink shared channel resources.

In Aspect 2, the method of Aspect 1 includes where selecting the comb pattern is based on multiple supported comb pattern types and associated comb pattern parameters.

In Aspect 3, the method of Aspect 2 includes obtaining, from a defined codebook, an indication of the multiple supported comb pattern types and associated comb pattern parameters.

In Aspect 4, the method of any of Aspects 1 to 3 includes where the comb pattern is a uniform comb pattern, and where the one or more parameters include one or more of a spacing between subcarriers, a total transmission bandwidth for the radar signal, or a duration of the radar signal.

In Aspect 5, the method of any of Aspects 1 to 4 includes where the comb pattern is a nested comb pattern, and where the one or more parameters include one or more of an indication of two or more nested uniform comb patterns with different inter-subcarrier spacing, a total transmission bandwidth for the radar signal, or a duration of the radar signal.

In Aspect 6, the method of any of Aspects 1 to 5 includes where the comb pattern is a non-uniform comb pattern, and where the one or more parameters include one or more of a set of resource element locations, a total transmission bandwidth for the radar signal, or a duration of the radar signal.

In Aspect 7, the method of any of Aspects 1 to 6 includes where selecting the comb pattern is based on a UE capability.

In Aspect 8, the method of Aspect 7 includes where the UE capability includes one or more of supported bandwidth, bands of operation, maximum duty cycle, maximum transmit power, or antenna gain and diversity.

In Aspect 9, the method of any of Aspects 1 to 8 includes receiving, from the one or more other UEs, one or more selection parameters related to selecting the comb pattern, where selecting the comb pattern is based at least in part on the one or more selection parameters.

In Aspect 10, the method of Aspect 9 includes where the one or more selection parameters include the comb pattern or comb pattern type to use.

In Aspect 11, the method of any of Aspects 9 or 10 includes where the one or more selection parameters include one or more of a resource requirement for radar sensing, or KPI requirements for radar sensing.

In Aspect 12, the method of Aspect 11 includes where the KPI requirements include one or more of a maximum range, Doppler, angular field-of-view, resolution in-range Doppler angular domain, update rate, maximum number of targets, target radar cross section (RCS), or minimum communication rate.

In Aspect 13, the method of any of Aspects 9 to 12 includes where the comb pattern is further based on prior channel information for the data channel over which the radar signal is transmitted.

In Aspect 14, the method of Aspect 13, includes obtaining the prior channel information based on scanning one or more sensors.

In Aspect 15, the method of Aspect 14 includes where the one or more sensors include a coarse range-Doppler angular estimate, number of targets, target RCS, time or frequency selectivity of the data channel, or pathloss estimate of the data channel.

In Aspect 16, the method of any of Aspects 1 to 15 includes where selecting the comb pattern includes determining whether to use comb-based allocation for the radar signal, or a size of one or more frequency allocation for the comb pattern for the radar signal.

In Aspect 17, the method of any of Aspects 1 to 16 includes where transmitting the SCI includes transmitting the SCI in contiguous symbols of a subchannel of multiple contiguous subcarriers.

In Aspect 18, the method of any of Aspects 1 to 17 includes where transmitting the SCI includes transmitting the SCI across multiple non-contiguous subcarriers corresponding to the comb pattern.

In Aspect 19, the method of Aspect 18 includes where the SCI in a given subcarrier of the multiple non-contiguous subcarriers includes an indication of a next subcarrier of the multiple non-contiguous subcarriers.

In Aspect 20, the method of any of Aspects 1 to 19 includes where the SCI indicates a starting resource element for an indicated number of future transmissions that have the comb pattern, and transmitting at least one subsequent radar signal at the starting resource element and based on the comb pattern.

Aspect 21 is a method for wireless communication at a UE including receiving, from a transmitting UE, SCI over sidelink control channel resources in a pool of resource allocated for sidelink communications, where the SCI indicates one or more parameters related to a comb pattern, and receiving, using the comb pattern, the radar signal from the transmitting UE over sidelink shared channel resources.

In Aspect 22, the method of Aspect 21 includes where the comb pattern is a uniform comb pattern, and where the one or more parameters include one or more of a spacing between subcarriers, a total transmission bandwidth for the radar signal, or a duration of the radar signal.

In Aspect 23, the method of any of Aspects 21 or 22 includes where the comb pattern is a nested comb pattern, and where the one or more parameters include one or more of an indication of two or more nested uniform comb patterns with different inter-subcarrier spacing, a total transmission bandwidth for the radar signal, or a duration of the radar signal.

In Aspect 24, the method of any of Aspects 21 to 23 includes where the comb pattern is a non-uniform comb pattern, and where the one or more parameters include one or more of a set of resource element locations, a total transmission bandwidth for the radar signal, or a duration of the radar signal.

In Aspect 25, the method of any of Aspects 21 to 24 includes transmitting, to the transmitting UE, one or more selection parameters related to selecting the comb pattern.

In Aspect 26, the method of Aspect 25 includes where the one or more selection parameters include the comb pattern or comb pattern type to use.

In Aspect 27, the method of any of Aspects 25 or 26 includes where the one or more selection parameters include one or more of a resource requirement for radar sensing, or KPI requirements for radar sensing.

In Aspect 28, the method of Aspect 27 includes where the KPI requirements include one or more of a maximum range, Doppler, angular field-of-view, resolution in-range Doppler angular domain, update rate, maximum number of targets, target RCS, or minimum communication rate.

In Aspect 29, the method of any of Aspects 21 to 28 includes where receiving the SCI includes receiving the SCI in contiguous symbols of a subchannel of multiple contiguous subcarriers.

In Aspect 30, the method of any of Aspects 21 to 29 includes where receiving the SCI includes receiving the SCI across multiple non-contiguous subcarriers corresponding to the comb pattern, and determining the comb pattern for the radar signal as including the multiple non-contiguous subcarriers.

In Aspect 31, the method of Aspect 30 includes where the SCI in a given subcarrier of the multiple non-contiguous subcarriers includes an indication of a next subcarrier of the multiple non-contiguous subcarriers, and where receiving the SCI includes receiving the SCI in the given subcarrier and the next subcarrier.

In Aspect 32, the method of any of Aspects 21 to 31 includes where the SCI indicates a starting resource element for an indicated number of subsequent transmissions that have the comb pattern, and receiving at least one subsequent radar signal at the starting resource element and based on the comb pattern.

Aspect 33 is an apparatus for wireless communication including a processor, memory coupled with the processor, and instructions stored in the memory and operable, when executed by the processor, to cause the apparatus to perform any of the methods of Aspects 1 to 32.

Aspect 34 is an apparatus for wireless communication including means for performing any of the methods of Aspects 1 to 32.

Aspect 35 is a computer-readable medium including code executable by one or more processors for wireless communications, the code including code for performing any of the methods of Aspects 1 to 32.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An apparatus for wireless communication, comprising:
a processor;
memory coupled with the processor; and
instructions stored in the memory and operable, when executed by the processor, to cause the apparatus to:
select a comb pattern for transmitting a radar signal that includes a data channel communication;
transmit, to one or more other user equipment (UEs), sidelink control information (SCI) over sidelink control channel resources in a pool of resources allocated for sidelink communications, wherein the SCI indicates one or more parameters related to the comb pattern; and
transmit, using the comb pattern, the radar signal to the one or more other UEs over sidelink shared channel resources.

2. The apparatus of claim 1, wherein the instructions, when executed by the processor, cause the apparatus to select the comb pattern based on multiple supported comb pattern types and associated comb pattern parameters.

3. The apparatus of claim 2, wherein the instructions, when executed by the processor, cause the apparatus to obtain, from a defined codebook, an indication of the multiple supported comb pattern types and associated comb pattern parameters.

4. The apparatus of claim 1, wherein the comb pattern is a uniform comb pattern, and wherein the one or more parameters include one or more of a spacing between subcarriers, a total transmission bandwidth for the radar signal, or a duration of the radar signal.

5. The apparatus of claim 1, wherein the comb pattern is a nested comb pattern, and wherein the one or more parameters include one or more of an indication of two or more nested uniform comb patterns with different inter-subcarrier spacing, a total transmission bandwidth for the radar signal, or a duration of the radar signal.

6. The apparatus of claim 1, wherein the comb pattern is a non-uniform comb pattern, and wherein the one or more parameters include one or more of a set of resource element locations, a total transmission bandwidth for the radar signal, or a duration of the radar signal.

7-8. (canceled)

9. The apparatus of claim 1, wherein the instructions, when executed by the processor, cause the apparatus to receive, from the one or more other UEs, one or more selection parameters related to selecting the comb pattern, wherein the instructions, when executed by the processor, cause the apparatus to select the comb pattern based at least in part on the one or more selection parameters.

10-14. (canceled)

15. The apparatus of claim 1, wherein the instructions, when executed by the processor, cause the apparatus to select the comb pattern at least in part by determining whether to use comb-based allocation for the radar signal, or a size of one or more frequency allocation for the comb pattern for the radar signal.

16. The apparatus of claim 1, wherein the instructions, when executed by the processor, cause the apparatus to transmit the SCI in contiguous symbols of a subchannel of multiple contiguous subcarriers.

17. The apparatus of claim 1, wherein the instructions, when executed by the processor, cause the apparatus to transmit the SCI across multiple non-contiguous subcarriers corresponding to the comb pattern, wherein the SCI in a given subcarrier of the multiple non-contiguous subcarriers includes an indication of a next subcarrier of the multiple non-contiguous subcarriers.

18. The apparatus of claim 1, wherein the SCI indicates a starting resource element for an indicated number of future transmissions that have the comb pattern, and wherein the instructions, when executed by the processor, cause the apparatus to transmit at least one subsequent radar signal at the starting resource element and based on the comb pattern.

19. An apparatus for wireless communication, comprising:
a processor;
memory coupled with the processor; and
instructions stored in the memory and operable, when executed by the processor, to cause the apparatus to:
receive, from a transmitting user equipment (UE), sidelink control information (SCI) over sidelink control channel resources in a pool of resource allocated for sidelink communications, wherein the SCI indicates one or more parameters related to a comb pattern; and
receive, using the comb pattern, the radar signal from the transmitting UE over sidelink shared channel resources.

20. The apparatus of claim 19, wherein the comb pattern is a uniform comb pattern, and wherein the one or more parameters include one or more of a spacing between subcarriers, a total transmission bandwidth for the radar signal, or a duration of the radar signal.

21. The apparatus of claim 19, wherein the comb pattern is a nested comb pattern, and wherein the one or more parameters include one or more of an indication of two or more nested uniform comb patterns with different inter-subcarrier spacing, a total transmission bandwidth for the radar signal, or a duration of the radar signal.

22. The apparatus of claim 19, wherein the comb pattern is a non-uniform comb pattern, and wherein the one or more parameters include one or more of a set of resource element locations, a total transmission bandwidth for the radar signal, or a duration of the radar signal.

23. The apparatus of claim 19, wherein the instructions, when executed by the processor, cause the apparatus to transmit, to the transmitting UE, one or more selection parameters related to selecting the comb pattern, wherein the one or more selection parameters include the comb pattern or comb pattern type to use.

24. The apparatus of claim 23, wherein the one or more selection parameters include one or more of a resource requirement for radar sensing, or key performance indicator (KPI) requirements for radar sensing, wherein the KPI requirements include one or more of a maximum range, Doppler, angular field-of-view, resolution in-range Doppler angular domain, update rate, maximum number of targets, target radar cross section (RCS), or minimum communication rate.

25. The apparatus of claim 19, wherein the instructions, when executed by the processor, cause the apparatus to receive the SCI in contiguous symbols of a subchannel of multiple contiguous subcarriers.

26. The apparatus of claim 19, wherein the instructions, when executed by the processor, cause the apparatus to receive the SCI across multiple non-contiguous subcarriers corresponding to the comb pattern, and wherein the instructions, when executed by the processor, cause the apparatus to determine the comb pattern for the radar signal as including the multiple non-contiguous subcarriers.

27. A method for wireless communication at a user equipment (UE), comprising:
selecting a comb pattern for transmitting a radar signal that includes a data channel communication;
transmitting, to one or more other UEs, sidelink control information (SCI) over sidelink control channel resources in a pool of resources allocated for sidelink communications, wherein the SCI indicates one or more parameters related to the comb pattern; and
transmitting, using the comb pattern, the radar signal to the one or more other UEs over sidelink shared channel resources.

28-30. (canceled)
